(19) United States
(12) Patent Application Publication
(10) Pub. No.: US 2025/0106673 A1
(43) Pub. Date: Mar. 27, 2025

(54) SYSTEMS AND METHODS FOR CHANNEL STATE INFORMATION MEASUREMENTS AND REPORTING

(71) Applicant: ZTE Corporation, Shenzhen (CN)

(72) Inventors: Xiaoying MA, Shenzhen (CN); Jun XU, Shenzhen (CN); Mengzhu CHEN, Shenzhen (CN); Hong TANG, Shenzhen (CN); Bo DAI, Shenzhen (CN); Qiujin GUO, Shenzhen (CN); Xuan MA, Shenzhen (CN)

(21) Appl. No.: 18/971,843

(22) Filed: Dec. 6, 2024

Related U.S. Application Data
(63) Continuation of application No. PCT/CN2022/140730, filed on Dec. 21, 2022.

(51) Int. Cl. H04W 24/10; H04W 72/231

(52) U.S. Cl. CPC H04W 24/10; H04W 72/231

(57) ABSTRACT

This disclosure is directed to methods, systems, and devices related to wireless communication, and more specifically, to methods, systems, and devices related to channel state information (CSI) measurement or CSI report based on different antenna ports. A method of wireless communication, comprising receiving, by a wireless communication device, from a network device, a radio resource control (RRC) signaling; wherein the RRC signaling includes at least a channel state information (CSI) report configuration and a CSI resource configuration; performing, by the wireless communication device, a CSI reporting according to the RRC signaling; and wherein the CSI reporting contains more than one CSI sub-reports.

### CROSS-REFERENCE TO RELATED APPLICATION

This application is a continuation and claims priority to International Application No. PCT/CN2022/140730, filed on Dec. 21, 2022, the disclosure of which is hereby incorporated by reference herein in its entirety.

### TECHNICAL FIELD

This disclosure is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed related to channel state information reporting that can be implemented by embodiments in mobile communication technology, including 5th Generation (5G), new radio (NR), 4th Generation (4G), and long-term evolution (LTE) communication systems.

In one example aspect, a wireless communication method is disclosed. The method includes receiving, by a wireless communication device, from a network device, a radio resource control (RRC) signaling; wherein the RRC signaling includes at least a channel state information (CSI) report configuration and a CSI resource configuration; performing, by the wireless communication device, a CSI reporting according to the RRC signaling; and wherein the CSI reporting contains more than one CSI sub-reports.

In another example aspect, another wireless communication method is disclosed. The method includes transmitting, to a wireless communication device, from a network device, a radio resource control (RRC) signaling; wherein the RRC signaling includes at least a channel state information (CSI) report configuration and a CSI resource configuration; receiving, by the network device, a CSI reporting according to the RRC signaling; and wherein the CSI reporting contains more than one CSI sub-reports.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 illustrates CSI sub-report associated with granularity.

FIG. 2 illustrates an example of simulation results of reporting multiple CSI in one report.

FIG. 3 illustrates another example of simulation results of reporting multiple CSI in one report.

FIG. 4 is a flowchart illustrating an example method.

FIG. 5 is a flowchart illustrating an example method.

FIG. 6 is a block diagram example of a wireless communication system.

FIG. 7 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

Large bandwidth, multi-antenna transmitters or receivers are used in 5G communication system. The large number of spatial elements cause a large power consumption. To reduce the power consumption of gNB, one potential method is reducing the number of antennas or antenna ports. However, the change of number of antennas or antenna ports may have impacts on UE CSI measurement or CSI reporting. Thus, this document presents a new method of channel state information (CSI) measurement or CSI report based on different antenna ports.

CSI measurement: UE (user equipment) shall perform measurements based on CSI-RS (reference signal) and may report corresponding report to gNB.

A UE can configure one or more CSI report configuration by CSI-ReportConfig signaling. The CSI-ReportConfig will associate with one or more CSI-RS resource setting by CSI-resourceConfigID. The CSI-RS resource setting is configured by CSI-ResourceConfig signaling.

One CSI-ReportConfig associates with only one CSI-ResourceConfig for a channel measurement. In one CSI reporting, usually one set of CSI parameters (one set of CSI parameters includes RI (rank indicator), CQI (channel quality indicator), PMI (precoding matrix indicator), CRI (resource indicator), L1-RSRP (a layer 1 reference signal received power), or L1-SINR (a layer 1 signal-to-noise and interference ratio)) is reported. In Release 17, in a CSI report, UE can report 4 pairs/groups and 2 beams per pair/group. The UE can report at most two RIs, two PMIs, two LIs (if configured), associated to the resource in Group 1 and the resource in Group 2, respectively, and at most two CQIs in one CSI reporting.

WidebandCQI: when wideband CQI reporting is configured, a wideband CQI is reported for each codeword for the entire CSI reporting band.

SubbandCQI: when subband CQI reporting is configured, one CQI for each codeword is reported for each subband in the CSI reporting band.

The number of ports of a CSI-RS is configured by nrofPorts in CSI-ResourceMapping, CSI-ResourceMapping is associated with an NZP-CSI-RS-Resource (CSI resource). NZP-CSI-RS-Resource is associated with an NZP-CSI-RS-ResourceSet (CSI resource set). An NZP-CSI-RS-Resource is associated with a CSI-ResourceConfig (CSI resource setting). A CSI-ResourceConfig is associated with a CSI-ReportConfig. The nrofPorts can be one of the following: p1, p2, p4, p8, p12, p16, p24, and p32. p32 means the resource is configured with 32 ports.

If the number of base station antenna changes, the channel may be changed as well. It is helpful if UE can provide channel measurement reports of different antenna port number. In prior art, most CSI-RS resource configuration and CSI report configurations are configured by RRC (Radio Resource Control) signaling. Usually, one CSI-ReportConfig associates with a CSI-ResourceConfig with one number of ports for channel measurement. Meaning one CSI report only includes a report about one number of ports. If UE needs to report CSI for multiple number of ports, UE should report multiple CSI in multiple CSI reporting and each CSI reporting includes a report about one number of ports. One CSI reporting needs one configuration of CSI-ReportConfig. Therefore, this method needs multiple CSI-ReportConfig signaling. Since the number of CSI-ReportConfig is limited for one BWP, configure multiple CSI-ReportConfig to report CSI for multiple number of ports is inappropriate.

In this document, a method that UE reports in a single reporting instance multiple CRI, RI, CQI, or PMI for each number of ports which are associated with a report setting is provided.

UE receives a RRC signaling that includes at least a CSI report configuration and a CSI resource configuration. Then UE performs a CSI reporting according to the RRC signaling. In contrast to the original CSI reporting, in this document, one CSI reporting contains more than one CSI reports, as known as CSI sub-reports.

In some embodiments, each CSI sub-report is reported for different number of ports.

In some embodiments, each CSI sub-report is reported for CSI-RS resource configured with different power control offset (powerControlOffset) or power control offset SS (powerControlOffsetSS).

In some embodiments, each CSI sub-report is reported for a resource.

Each resource may associate with a number of ports or a power offset or a time and frequency resource configuration. In some embodiments, a resource includes one or more CSI resource including at least one of the following: a CSI resource, a CSI resource set, a CSI resource group, a CSI resource setting, and a CSI resource set group. A CSI report configuration is associated with a CSI resource configuration (CSI-resourceConfig). A CSI resource configuration corresponds to a CSI resource setting. A CSI resource setting may include one or more CSI resource set. A CSI resource set may include one or more CSI resource. A CSI resource include a CSI resource mapping. A CSI resource group includes one or more CSI resource. In some embodiments, CSI resources are divided into multiple groups. A CSI resource set group includes one or more CSI resource set. In some embodiments, CSI resource sets are divided into multiple groups

Different resource includes at least: resource with different number of ports, resource with different power control offset, resource with different power control offset SS, resource with different time or frequency resource configuration.

In some embodiments, a first resources which associate with first CSI sub-report is a subset of the second resources which associate with the second CSI sub-reports. In some embodiments, subset means the time and frequency resource of the first resource is part (or subset) of the time and frequency resource of the second resource. In some embodiments, a first resource is a subset of a second resource means the number of ports which associate with a first resource is less than or equal to the number of ports which associate with a second resource. In some embodiments, a first resource is a subset of a second resource means the power control offset which associate with a first resource is greater than or equal to the power control offset which associate with a second resource. In some embodiments, a first resource is a subset of a second resource means the first resource is overlapped with the second resource. In some embodiments, a first resource is a subset of a second resource means the power control offset SS which associate with a first resource is less than or equal to the power control offset SS which associate with a second resource.

In each CSI sub-report, multiple CSI parameters are reported. The CSI parameters include at least one of the following: Channel Quality Indicator (CQI) (e.g., wideband CQI, subband CQI), precoding matrix indicator (PMI), CSI-RS resource indicator (CRI), rank indicator (RI), Layer 1 reference signal received power (L1-RSRP), L1-signal-to-noise and interference ratio (SINR).

In this document, one CSI reporting contains more than one CSI sub-reports, and the CSI sub-reports are jointly reported. Jointly reported means the same kind of CSI parameter for all CSI sub-report are reported together.” For example, CSI parameters include RI and CQI. And 3 CSI sub-reports are reported in one CSI reporting, the 3 RIs are reported together and then 3 CQIs are reported together. In some embodiments, all CSI parameters in one sub-report are reported/placed together, and then CSI parameters in another sub-report are reported. In another word, the CSI parameters are sub-report by sub-report reported.

In this document, one CSI reporting contains more than one CSI reports correspond to multiple CSI sub-reports. In this document, power offset corresponds to powerControlOffset or powerControlOffsetSS. In this document, number of ports means number of CSI-RS ports. In this document, power offset is as known as transmission power offset.

powerControlOffset: which is the assumed ratio of PDSCH EPRE to NZP CSI-RS EPRE when UE derives CSI feedback and takes values in the range of [−8, 15] dB with 1 dB step size.

powerControlOffsetSS: which is the assumed ratio of NZP (Non-zero power) CSI-RS EPRE to SS/PBCH (Synchronisation signal/Physical broadcast channel) block EPRE (Energy per resource element).)

The multiple CSI sub-reports include CSI parameters for CSI resource associated with different number of ports or different power offset or different resource. Therefore, the bitwidth of the multiple CSI sub-reports becomes large and will need more signal overhead. For example, if a CSI reporting includes 4 CSI sub-reports, the bitwidth increases to 4 times of the original bitwidth. Some method to reduce the signal overhead of CQI is provided in this section.

### Wideband CQI

In some embodiments, the wideband CQI reported of multiple CSI sub-reports in one CSI reporting is reported or encoded separately. A differential or an offset wideband CQI is used to be reported. UE reports a wideband CQI is same as UE reports a wideband CQI index. In another word, UE reports a first CSI parameter of a first CSI sub-report and reports an offset value of the first CSI parameter of a second sub-report, wherein the offset value is an offset between a first reference CSI parameter and the first CSI parameter of a second sub-report. In this section, the first CSI parameter is a wideband CQI.

In some embodiments, a first CSI parameter of a first CSI sub-report is the wideband CQI of a CSI sub-report which is associated with a maximum number of ports or a maximum power offset or largest resource. The first CSI parameter of the first CSI sub-report is reported directly. The wideband CQI associated with the other number of ports or power offset, or other resource are reported via an offset wideband CQI value.

In some embodiments, a first CSI parameter of a first CSI sub-report is the maximum wideband CQI index in the CSI reporting. In some embodiments, a maximum wideband CQI index is reported directly. The number of ports or the power offset or resource that is associated with the maximum wideband CQI index is also indicated/reported. The wideband CQI associated with the other number of ports or power offset, or resource are reported via a differential or an offset wideband CQI value.

In some embodiments, a wideband CQI index associated with maximum number of ports or maximum power offset, or largest resource is reported directly. The number of ports or the power offset or resource which is associated with the wideband CQI index is also indicated/reported. The wideband CQI index associated with the other number of ports or power offset, or resource are reported via a differential or an offset wideband CQI index.

In some embodiments, maximum power offset means maximum power control offset SS or minimum power control offset or maximum CSI-RS transmission power.

The differential or the offset wideband CQI indicates difference between a reference wideband CQI and the wideband CQI. The reference wideband CQI for the offset wideband CQI for difference CSI sub-report can be different.

In some embodiments, the differential or the offset wideband CQI for the other resource is reported in a predefined order. In some embodiments, the wideband CQI for the other resource is reported in a predefined order. In some embodiments, the wideband CQI reported in one CSI reporting is reported in a predefined order.

### Example 1: A CSI Reporting Includes 3 Sub-Reports

UE reports “wideband CQI index of CSI sub-report #1, offset value of wideband CQI index of CSI sub-report #2, offset value of wideband CQI index of CSI sub-report #3.

offset value of wideband CQI index of CSI sub-report #2=wideband CQI index of CSI sub-report #1−wideband CQI index of CSI sub-report #2

offset value of wideband CQI index of CSI sub-report #3=wideband CQI index of CSI sub-report #2−wideband CQI index of CSI sub-report #3

The predefined order is one of the following: the order of a CRI, the order of resource ID which associate with a CSI sub-report, the order of resource group ID which associate with a CSI sub-report, the order of associated number of ports (e.g., from large to small, or from small to large), the order of associated power offset (e.g., from large to small, or from small to large), an order configured by high layer signaling or a predefined order, the order of number of ports/power offset configured in the CSI report configuration. In some embodiments, each CSI sub-report is associated with a CRI.

In some embodiments, the predefined order is the order of associated number of ports. For example, wideband CQI of CSI sub-reports which associate with 32, 16, 8, 4 ports, respectively, are to be reported in one CSI reporting. The wideband CQI of CSI sub-reports which associate with 32 ports is reported directly. The differential or the offset wideband CQI for other number of ports are reported according to the order of: the differential or the offset wideband CQI associates with 16 ports, the differential or the offset wideband CQI associates with 8 ports, the differential or the offset wideband CQI associates with 4 ports. Wideband CQI associates a number of ports means wideband CQI associates of a CSI sub-report which associate with a number of ports.

The order of number of ports or the power offset configured in the CSI report configuration means the order index of ordering for each number of ports or power offset first in CSI resource (e.g., NZP-CSI-RS-Resource) order, and then in CSI resource set (NZP-CSI-RS-ResourceSet) order, and then in CSI resource setting (CSI-ResourceConfig) order linked to a CSI report configuration.

For example, a CSI-ResourceConfig includes CSI resource configured with multiple CSI resource sets. The first CSI resource set includes CSI resource configured with a first number of ports (e.g., 8 ports) and CSI resource configured with a second number of ports (e.g., 32 ports). The second CSI resource set includes CSI resource configured with a third number of ports (e.g., 16 ports) and CSI resource configured with a fourth number of ports (e.g., 24 ports). The order of reported wideband CQI is according to the wideband CQI index of 8 ports, the wideband CQI index of 32 ports, the wideband CQI index of 16 ports, the wideband CQI index of 24 ports.

In some embodiments, the reference wideband CQI is one of the following:

1. Wideband CQI which is associated with maximum number of ports or maximum power offset or largest resource in the same CSI reporting.

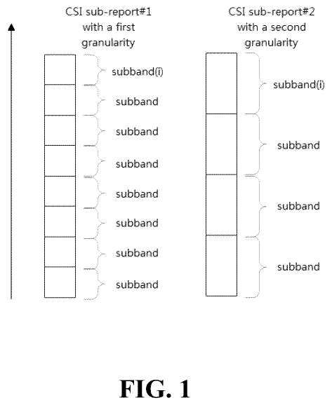

2. Maximum wideband CQI index in the same CSI reporting. There is a need of addition bits to indicate which resource or number of ports or power offset the maximum wideband CQI belongs to or associated with. In some embodiments, the addition bits may indicate at least one of the following: an index/codepoint associate with number of ports or power offset or resource which the maximum wideband CQI index associated with (For example, 4 wideband CQIs associate with 4 number of ports are reported in one CSI reporting. The 4 number of ports are 32, 24, 16, 8, an index/codepoint 00, 01, 10, 11 correspond to 32, 24, 16, 8, respectively. Then addition 2 bits are used to indicate the index/codepoint of the maximum wideband CQI index. Another example, 2 wideband CQIs associate with 2 power offsets are reported in one CSI reporting. The 2 power offsets are −8, −6 dB. An index/codepoint 0, 1 correspond to −8, −6 dB, respectively); CRI of the maximum wideband CQI; an index/codepoint indicates the position/number of associated number of ports or power offset among all the number of ports or power offset in the CSI report configuration (For example, an index/codepoint indicates the maximum wideband CQI is associated with the first/second/third/forth number of ports as shown in FIG. 1).

3. A wideband CQI which is associated with a predefined number of ports or power offset or predefined resource.

4. A prior wideband CQI index. The prior wideband CQI index of the N^{th} wideband CQI index is the N−1^{th} wideband CQI index. For example, the reference wideband CQI of the N^{th} wideband CQI is the N−1^{th} wideband CQI.

The maximum/largest resource corresponds to at least one of the following: resource associate with maximum number of ports, resource associate with maximum power offset, resource associate with a time and frequency resource which is a union (or whole) set among all the resource which associate with a same CSI reporting.

In some embodiments, the differential or the offset wideband CQI index indicates a value X which means the wideband CQI index is X smaller than the reference wideband CQI index. X is an integer greater than or equal to 0 and less than 10. In some embodiments, X can be 0, 1. In some embodiments, X can be 0, 1, 2, 3. In some embodiments, X can be 0, 1, 2, 4. In another word, the wideband CQI index derived from the differential or the offset wideband CQI index and the reference wideband CQI index is equal to reference wideband CQI index-X.

In some embodiments, the differential or the offset wideband CQI index indicate a number of steps (e.g., U) corresponding to a reference wideband CQI index. The step size is 1 or 2 or 3 or 4, the wideband CQI index derived by the differential or the offset wideband CQI index is equal to reference wideband CQI index−U*step size. U is an integer greater than or equal to 0 and less than 10.

| | wideband CQI | wideband CQI | wideband CQI | wideband CQI |
|---|---|---|---|---|
| | index#1 | index#2 | index#3 | index#4 |
| | wideband CQI | Differential | Differential | Differential |
| | index for | wideband CQI | wideband CQI | wideband CQI |
| | maximum | index for second | index for third | index for forth |
| content | number of ports | number of ports | number of ports | number of ports |
| Example 1 | 15 | 0 | 2 | 3 |
| Example 2 (step | 14 | 0 | 1 | 2 |
| size = 2) | | | | |
| Example 3 | 12 | 0 | 1 | 1 |

In the above examples, 4 wideband CQI index need to be reported, wideband CQI index for maximum number of ports is reported. The wideband CQI index for the other number of ports are reported using the differential or the offset wideband CQI index.

In example 1, reference wideband CQI index is the wideband CQI index for maximum number of ports. The offset wideband CQI index indicates a X, the wideband CQI index is equal to reference wideband CQI index −X. Hence, wideband CQI index #2=15−0=15, wideband CQI index #3=15−2=13, wideband CQI index #4=15−3=12.

In example 2, reference wideband CQI index is the wideband CQI index for maximum number of ports. The differential or the offset wideband CQI index indicates a U, the wideband CQI index is equal to reference wideband CQI index −U*step size. Hence, wideband CQI index #2=14−0*2=14, wideband CQI index #3=14−1*2=12, wideband CQI index #4=14−2*2=10.

In example 3, reference wideband CQI index is the prior wideband CQI index. The differential or the offset wideband CQI index indicates a X, the wideband CQI index is equal to reference wideband CQI index −X. Hence, wideband CQI index #2=12−0=12, wideband CQI index #3=12−1=11, wideband CQI index #4=11−1=10.

In some embodiments, the wideband CQI indexes for different resource or different number of ports or different power offsets are reported via different granularity.

The granularity may be configured by RRC signaling.

In some embodiments, only the wideband CQI indexes which are associated with a maximum number of ports or a maximum power offsets or largest resource are reported. The wideband CQI indexes for other number of ports or power offset or resource are the same as the wideband CQI indexes for the maximum number of ports or maximum power offsets.

### Subband CQI

In some embodiments, the subband CQI indexes for multiple CSI sub-reports reported in one CSI reporting are reported or encoded separately. Each CSI sub-report is associated with a number of ports or power offsets or resource.

In some embodiments, the subband CQI index which is associated with a maximum number of ports or a maximum power offset or maximum resource is reported directly. The subband CQI indexes associated with the other number of ports or power offsets or resources are reported via the differential or the offset subband CQI indexes. The differential or the offset subband CQI index indicates difference between a reference CQI and the subband CQI index. The reference CQI for the offset subband CQI for difference CSI sub-report can be different.

The method used for the differential or the offset wideband CQI values can be also used for the differential or the offset subband CQI index.

In some embodiments, the reference CQI index is one of the following: a wideband CQI index for a maximum number of ports or a maximum power offset, wideband CQI indexes for the number of ports or power offset or resource is the same as the number of ports or power offset or resource for the subband CQI, subband CQI index for the prior resource, which the order may be the same as the order in wideband CQI section, and subband CQI index for the maximum number of ports or largest resource.

In some embodiments, only the subband CQI indexes which are associated with a maximum number of ports or a maximum power offsets or largest resource are reported. The subband CQI indexes for other number of ports or power offset or resource are the same as the subband CQI indexes for the maximum number of ports or maximum power offsets.

In some embodiments, UE reports an offset value of a second CSI parameter of a CSI sub-report, wherein an offset value is an offset between a second reference CSI parameter and the second CSI parameter of a CSI sub-report; wherein the second CSI parameter is a subband CQI index.

In some embodiments, the second reference CSI parameter is wideband CQI in a CSI sub-report. In some embodiments, the second reference CSI parameter is subband CQI in a CSI sub-report. In some embodiments, the second reference CSI parameter is subband CQI in a prior CSI sub-report.

### Example 1: A CSI Reporting Includes 3 Sub-Reports

UE reports “wideband CQI index of CSI sub-report #1, offset value of wideband CQI index of CSI sub-report #2, offset value of wideband CQI index of CSI sub-report #3, offset value of subband CQI index of CSI sub-report #1, offset value of subband CQI index of CSI sub-report #2, offset value of subband CQI index of CSI sub-report #3.” Subband CQI index (i) means the subband CQI index for the i^{th} subband.

In this example, UE reports a wideband CQI index of CSI sub-report #1 and reports “an offset value of the wideband CQI index of a sub-report #2 and sub-report ##3, and an offset value of the subband CQI index of a sub-report #1” according to a first reference CSI parameter. The first reference CSI parameter is the wideband CQI index of CSI sub-report #1. UE also reports an offset value of the subband CQI index of a sub-report #2 and sub-report #3 according to a second reference CSI parameter, the second reference CSI parameter is the subband CQI index of a sub-report #1. Hence,

offset value of wideband CQI index of CSI sub-report #2=wideband CQI index of CSI sub-report #1−wideband CQI index of CSI sub-report #2

offset value of wideband CQI index of CSI sub-report #3=wideband CQI index of CSI sub-report #1−wideband CQI index of CSI sub-report #3

Offset value of subband CQI index (i) of CSI sub-report #1=wideband CQI index of CSI sub-report #1−subband CQI index (i) of CSI sub-report #1

Offset value of subband CQI index (i) of CSI sub-report #2=subband CQI index (i) of CSI sub-report #1−subband CQI index (i) of CSI sub-report #2

Offset value of subband CQI index (i) of CSI sub-report #3=subband CQI index (i) of CSI sub-report #1−subband CQI index (i) of CSI sub-report #3

### Example 2: A CSI Reporting Includes 3 Sub-Reports

UE reports “wideband CQI index of CSI sub-report #1, offset value of wideband CQI index of CSI sub-report #2, offset value of wideband CQI index of CSI sub-report #3, offset value of subband CQI index of CSI sub-report #1, offset value of subband CQI index of CSI sub-report #2, offset value of subband CQI index of CSI sub-report #3.” subband CQI index (i) means the subband CQI index for the i^{th} subband.

In this example, UE reports a wideband CQI index of CSI sub-report #1, and UE reports an offset value of the wideband CQI index of a sub-report #2 and sub-report #3, and an offset value of the subband CQI index of a sub-report #1, sub-report #2, sub-report #3 according to a first reference CSI parameter. The first reference CSI parameter is the wideband CQI index of CSI sub-report #1. Hence,

offset value of wideband CQI index of CSI sub-report #2=wideband CQI index of CSI sub-report #1−wideband CQI index of CSI sub-report #2

offset value of wideband CQI index of CSI sub-report #3=wideband CQI index of CSI sub-report #1−wideband CQI index of CSI sub-report #3

Offset value of subband CQI index (i) of CSI sub-report #1=wideband CQI index of CSI sub-report #1−subband CQI index (i) of CSI sub-report #1

Offset value of subband CQI index (i) of CSI sub-report #2=wideband CQI index of CSI sub-report #1−subband CQI index (i) of CSI sub-report #2

Offset value of subband CQI index (i) of CSI sub-report #3=wideband CQI index of CSI sub-report #1−subband CQI index (i) of CSI sub-report #3

### Example 3: A CSI Reporting Includes 3 Sub-Reports

UE reports “wideband CQI index of CSI sub-report #1, offset value of wideband CQI index of CSI sub-report #2, offset value of wideband CQI index of CSI sub-report #3, offset value of subband CQI index of CSI sub-report #1, offset value of subband CQI index of CSI sub-report #2, offset value of subband CQI index of CSI sub-report #3.” Subband CQI index (i) means the subband CQI index for the i^{th} subband.

In this example, UE reports a wideband CQI index of CSI sub-report #1, and UE reports an offset value of the wideband CQI index of a sub-report #2 and sub-report #3 according to a first reference CSI parameter. UE reports an offset value of the subband CQI index of a sub-report #1 according to a reference CSI parameter which is the wideband CQI index of CSI sub-report #1. UE reports offset values of the subband CQI index of a sub-report #2, sub-report #3 according to a second reference CSI parameter. The first reference CSI parameter is the prior wideband CQI index. The second reference CSI parameter is the prior subband CQI index. Hence,

offset value of wideband CQI index of CSI sub-report #2=wideband CQI index of CSI sub-report #1-wideband CQI index of CSI sub-report #2

offset value of wideband CQI index of CSI sub-report #3=wideband CQI index of CSI sub-report #2-wideband CQI index of CSI sub-report #3

Offset value of subband CQI index (i) of CSI sub-report #1=wideband CQI index of CSI sub-report #1-subband CQI index (i) of CSI sub-report #1

Offset value of subband CQI index (i) of CSI sub-report #2=subband CQI index of CSI sub-report #1-subband CQI index (i) of CSI sub-report #2

Offset value of subband CQI index (i) of CSI sub-report #3=subband CQI index of CSI sub-report #2-subband CQI index (i) of CSI sub-report #3

The maximum/largest resource corresponds to at least one of the following: resource associate with maximum number of ports, resource associate with maximum power offset, resource associate with a time and frequency resource which is a union (or whole) set among all the resource which associate with a same CSI reporting.

In some embodiments, parts of the subband CQI index are reported. For example, only the subband CQI index which is associated with the M^{th} largest wideband CQI index are reported.

### Other Consideration:

In some embodiments, wideband CQI for multiple CSI sub-reports which are reported in one CSI reporting are joint encoded. In some embodiments, joint encoded means a codepoint is used to indicate the wideband CQI for multiple CSI sub-reports. For example, a codepoint is associated with multiple predefined wideband CQI values, each wideband CQI value is used for one CSI sub-report. A predefined table which includes multiple codepoints and the associated wideband CQI values is used.

In some embodiments, joint encoded means an encoding method is used to encode the bits of wideband CQI for multiple CSI sub-reports. Using encoding method can reduce the signaling overhead.

In some embodiments, a CSI report configuration may associate with M resource. UE may report N CSI sub-reports in one CSI reporting. N is less than or equal to M. In some embodiments, N is configured in a CSI report configuration. In some embodiments, N is a predefined value. In some embodiments, N is a UE capability reported by UE.

In some embodiments, a CSI report configuration may associate with M resource. UE may report the best N CSI sub-reports in one CSI reporting. The best N CSI sub-reports in one CSI reporting means the top N largest wideband CQI index among all the sub-reports.

In some embodiments, more than one subband size and/or CSI-reportingBand are associated with one CSI reporting which contains multiple CSI report.

CSI sub-report with different number of ports or different power offset or different resource can associate with different subband size and/or CSI-reportingBand.

For example, two subband size and CSI-reportingBand is configured in one CSI report configuration. The CSI report configuration associates with more than one number of ports or more than one power offsets or more than one resources. One subband size and corresponding CSI-reportingBand are used for the subband CQI sub-report for the maximum number of ports or maximum power offset or largest resource. The other subband size and corresponding CSI-reportingBand are used for the other subband CQI sub-report. According to this method, subband CQI associated with different number of ports or different power offsets or resources are reported based on different granularity and save signaling overhead. A PDSCH with a smaller number of ports or smaller power offset may need more resource, and thus, a coarse granularity may be enough.

In some embodiments, more than one cqi-BitsPerSubband are configured in one CSI report configuration. CSI sub-report with different number of ports or different power offset or different resource can associate with different cqi-BitsPerSubband.

csi-ReportingBand: Indicates a contiguous or non-contiguous subset of subbands in the bandwidth part which CSI shall be reported for. Each bit in the bit-string represents one subband. The right-most bit in the bit string represents the lowest subband in the BWP.

In some embodiments, one or more CSI sub-reports can associate with a same cqi-BitsPerSubband or subband size or CSI-reportingBand.

In some embodiments, different cqi-BitsPerSubband or subband size or CSI-reportingBand may associate with one or more CSI sub-reports.

cqi-BitsPerSubband: This field can only be present if cqi-FormatIndicator is set to subbandCQI. If the field is configured with bits4, the UE uses 4-bit sub-band CQI. If the field is not present and cqi-FormatIndicator is set to subbandCQI, the UE uses 2-bit sub-band differential CQI.)

As shown in FIG. 1, CSI sub-report #1 is associated with a first granularity and CSI sub-report #2 is associated with a second granularity. For example, the subband size associated with CSI sub-report #1 is less than the subband size associated with CSI sub-report #2. Then the number of subband CQI index for CSI sub-report #2 is reduced and the overhead is reduced.

In some embodiments, a CSI report configuration associate with one resource. UE reports multiple sub-reports which is according to the resource. Each sub-report is calculated by UE according to subset of the resource (e.g., part of ports, part of CDM (code division multiplexing) groups).

UE also report a sub-report index which is associate or indicator of the subset of resource. In some embodiments, UE report port index of subset resource. In some embodiments, the subset of the resource is predefined or indicated by gNB. In some embodiments, at most 1 or 2 sub-report for subset of resource are reported.

In some embodiments, multiple CSI sub-reports in one CSI reporting is enabled if at least one of the following is satisfied: UE supports dynamic adaptation of gNB antennas/ports; a network energy saving technique is enabled/open; a spatial network energy saving technique is enabled/open; gNB indicates start an energy saving state; a network energy saving information is configured.

In some embodiments, a CSI resource configuration associate with one or more CSI report configuration. Each CSI report configuration is associated with a CSI sub-report. The CSI sub-reports for the CSI report configuration which associate with a same CSI resource configuration is reported in one CSI reporting.

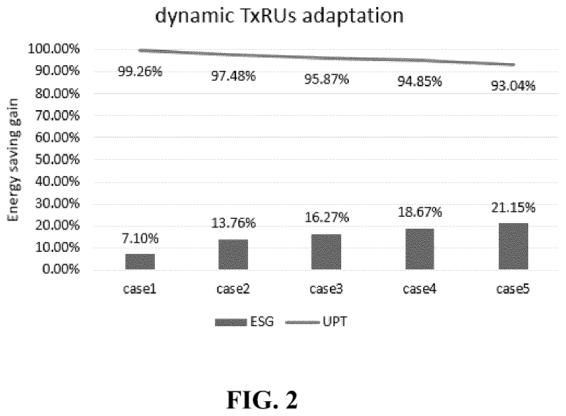

FIG. 2 illustrates an example of simulation results of reporting multiple CSI in one report. UE performs measurements and generates (or calculates) multiple CSI according to CSI resource associate with different number of ports and reports the multiple CSI in one reporting. gNB can dynamically adapt the number of TxRUs among {64TxRUs, 32TxRUs, 16TxRUs, 8TxRUs, 4TxRUs}, based on the CSI reporting. When gNB turns off some TxRUs, the power consumption can be reduced.

According to the simulation results, dynamic adapt TxRUs according to the multiple CSI in one report has at most 21.15% energy saving gain compared with Baseline scheme. The Baseline scheme is gNB always turns on 64TxRUs.

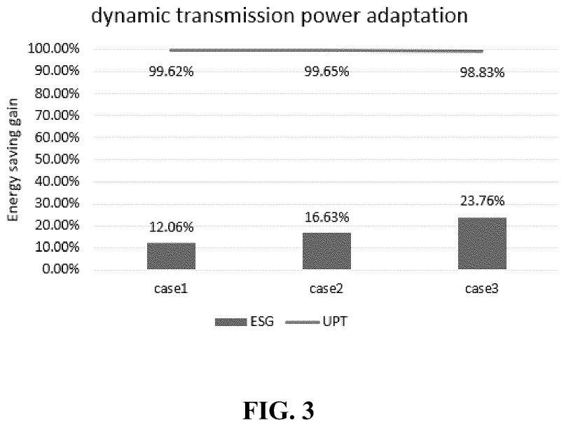

FIG. 3 illustrates another example of simulation results of reporting multiple CSI in one report. UE performs measurements and generates multiple CSI according to CSI resource associate with different power offsets configuration and reports the multiple CSI in one reporting. gNB can dynamically adapt the transmission power of PDSCH among {55 dBm, 52 dBm, 49 dBm, 46 dBm, 43 dBm}, based on the CSI reporting. When gNB reduces the transmission power, the power consumption can be reduced.

According to the simulation results, dynamic adapt transmission power according to the multiple CSI in one report has at most 23.76% energy saving gain compared with Baseline scheme. The Baseline scheme is the transmission power is always 55 dBm.

Accordingly, some preferred embodiments may use the following solutions.

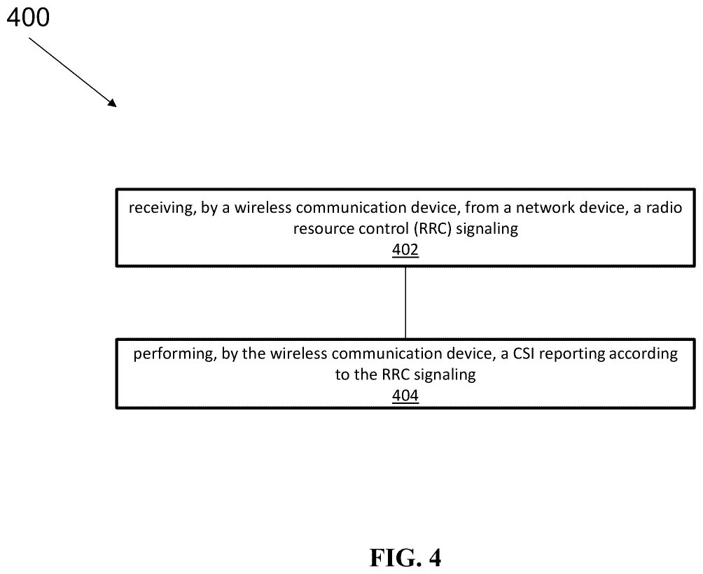

1. A method of wireless communication, as disclosed in FIG. 4: including receiving, by a wireless communication device, from a network device, a radio resource control (RRC) signaling (402); wherein the RRC signaling includes at least a channel state information (CSI) report configuration and a CSI resource configuration; performing, by the wireless communication device, a CSI reporting according to the RRC signaling (404); and wherein the CSI reporting contains more than one CSI sub-reports. Additional details and examples are discussed in the detailed description and with reference to FIGS. 1 to 3.

2. The method of solution 1, wherein each CSI sub-report includes multiple CSI parameters.

3. The method of solution 2, wherein a resource is associated with each CSI sub-report for the CSI reporting.

4. The method of solution 3, wherein the resource is associated with the multiple CSI parameters in the CSI sub-reports for CSI reporting.

5. The method of solution 3, wherein a first resource is associated with a first CSI sub-report for the CSI reporting; wherein a second resource is associated with a second CSI sub-report for the CSI reporting; wherein the first resource is different from the second resource; and wherein the first resource is within a subset of the second resource.

6. The method of solution 4, wherein the more than one CSI sub-reports are jointly reported; wherein the jointly reported CSI sub-reports contain at least one of the same CSI parameter; wherein the same CSI parameter are jointly coded and reported instantly.

7. The method of solution 2, wherein performing, by the wireless communication device, a CSI reporting according to the RRC signaling further comprising: reporting a first CSI parameter of a first CSI sub-report; or reporting an offset value of a first CSI parameter of a second CSI sub-report; wherein the offset value is a difference between a first reference CSI parameter and the first CSI parameter of the second sub-report.

8. The method of solution 7, wherein the CSI parameter is a wideband channel quality indicator (CQI) or a subband CQI.

9. The method of solution 8, wherein when the CSI reporting contains at least three CSI sub-reports, the first reference CSI parameter of a first CSI parameter in a Nth CSI sub-report is the first CSI parameter in a (N−1)th CSI sub-report.

10. The method of solution 9, wherein N is an integer number between 2 and 9.

11. The method of solution 8, wherein the first reference CSI parameter is at least one of the following: a wideband CQI of a type of CSI sub-report, a wideband CQI of a CSI sub-report which is associated with a predefined resource, a wideband CQI of a CSI sub-report which is associate with a largest resource, a wideband CQI of a prior CSI sub-report.

12. The method of solution 8, wherein the first reference CSI parameter is a maximum first CSI parameter of a CSI sub-report in the CSI reporting; reporting a resource ID associated with the maximum first CSI parameter of the CSI sub-report.

13. The method of solution 2, wherein performing, by the wireless communication device, a CSI reporting according to the RRC signaling further comprising: reporting an offset value of a second CSI parameter of a CSI sub-report; wherein an offset value is a difference between a second reference CSI parameter and the second CSI parameter of the CSI sub-report; and wherein the second CSI parameter is a subband CQI index.

14. The method of solution 13, wherein the second reference CSI parameter is at least one of the following: a wideband CQI of a CSI sub-report, a wideband CQI of a CSI sub-report which is associated with a predefined resource, a wideband CQI of in a CSI sub-report which is associated with a largest resource, a maximum wideband CQI of a CSI sub-report, a subband CQI of a CSI sub-report, a subband CQI in a CSI sub-report which is associated with a largest resource, a subband CQI of a CSI sub-report which is associated with a predefined resource, a subband CQI of a prior sub-report.

15. The method of solutions 7 and 13, the CSI parameter or offset value of the CSI sub-report in the CSI reporting are reported or encoded according to a predefined order; wherein the predefined order based on at least one of the following: a resource identification (ID), a resource group ID associated with a CSI reporting, the number of ports, the transmission power offsets, an order configured by a high layer signaling, a preconfigured order, and the number of ports or the transmission power offsets indicated in the CSI report configuration.

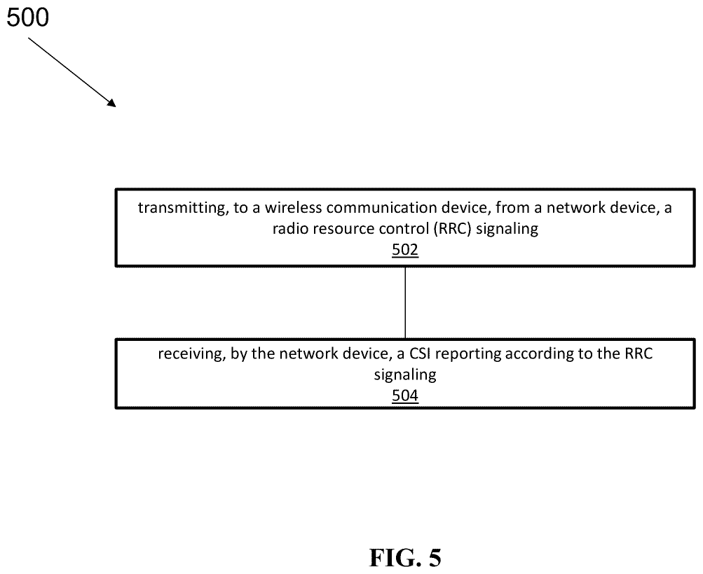

16. A method of wireless communication, as disclosed in FIG. 5: including transmitting, to a wireless communication device, from a network device, a radio resource control (RRC) signaling (502); wherein the RRC signaling includes at least a channel state information (CSI) report configuration and a CSI resource configuration; receiving, by the network device, a CSI reporting according to the RRC signaling (504); and wherein the CSI reporting contains more than one CSI sub-reports. Additional details and examples are discussed in the detailed description and with reference to FIGS. 1 to 3.

17. The method of solution 16, wherein each CSI sub-report includes multiple CSI parameters.

18. The method of solution 17, wherein a resource is associated with each CSI sub-report for the CSI reporting.

19. The method of solution 18, wherein the resource is associated with the multiple CSI parameters in the CSI sub-reports for CSI reporting.

20. The method of solution 18, wherein a first resource is associated with a first CSI sub-report for the CSI reporting; wherein a second resource is associated with a second CSI sub-report for the CSI reporting; wherein the first resource is different from the second resource; and wherein the first resource is within a subset of the second resource.

21. The method of solution 19, wherein the more than one CSI sub-reports are jointly reported; wherein the jointly reported CSI sub-reports contain at least one of the same CSI parameter; and wherein the same CSI parameter are jointly coded and reported instantly.

22. The method of solution 17, wherein receiving, by the network device, a CSI reporting according to the RRC signaling further comprising: receiving a first CSI parameter of a first CSI sub-report; or receiving an offset value of a first CSI parameter of a second CSI sub-report; wherein the offset value is a difference between a first reference CSI parameter and the first CSI parameter of the second sub-report.

23. The method of solution 22, wherein the CSI parameter is a wideband channel quality indicator (CQI) or a subband CQI

24. The method of solution 23, wherein when the CSI reporting contains at least three CSI sub-reports, the first reference CSI parameter of a first CSI parameter in a Nth CSI sub-report is the first CSI parameter in a (N−1)th CSI sub-report.

25. The method of solution 24, wherein N is an integer number between 2 and 9.

26. The method of solution 23, wherein the first reference CSI parameter is at least one of the following: a wideband CQI of a type of CSI sub-report, a wideband CQI of a CSI sub-report which is associated with a predefined resource, a wideband CQI of a CSI sub-report which is associate with a largest resource, a wideband CQI of a prior CSI sub-report.

27. The method of solution 23, wherein the first reference CSI parameter is a maximum first CSI parameter of a CSI sub-report in the CSI reporting; reporting a resource ID associated with the maximum first CSI parameter of the CSI sub-report.

28. The method of solution 17, wherein receiving, by the network device, a CSI reporting according to the RRC signaling further comprising: receiving an offset value of a second CSI parameter of a CSI sub-report; wherein an offset value is a difference between a second reference CSI parameter and the second CSI parameter of the CSI sub-report; and wherein the second CSI parameter is a subband CQI index.

29. The method of solution 28, wherein the second reference CSI parameter is at least one of the following: a wideband CQI of a CSI sub-report, a wideband CQI of a CSI sub-report which is associated with a predefined resource, a wideband CQI of in a CSI sub-report which is associated with a largest resource, a maximum wideband CQI of a CSI sub-report, a subband CQI of a CSI sub-report, a subband CQI of in a CSI sub-report which is associated with a largest resource, a subband CQI of a CSI sub-report which is associated with a predefined resource, a subband CQI of a prior sub-report.

30. The method of solutions 22 and 28, the CSI parameters or offset value of the CSI sub-report in the CSI reporting are reported or encoded according to a predefined order; wherein the predefined order based on at least one of the following: a resource identification (ID), a resource group ID associated with a CSI reporting, the number of ports, the transmission power offsets, an order configured by a high layer signaling, a preconfigured order, and the number of ports or the transmission power offsets indicated in the CSI report configuration.

31. The method of solutions 1 and 16, wherein the CSI report configuration contains more than one subband size or CSI-reportingBand configuration; wherein a different resource can be associated with the different subband size or CSI-reportingBand configuration.

32. The method of solutions 1 and 16, wherein the CSI report configuration contains more than one CQI bits per subband (cqi-BitsPerSubband) configuration; wherein a different resource can be associated with a different CQI bits per subband configuration.

33. The method of solutions 1-4 and 16-19, wherein the CSI parameter associated with different resource are reported via a different granularity; wherein the different granularity may be configured by the RRC signaling or predefined.

34. The method of solutions 3-5 and 16-18, wherein the resource is at least one of the following: a CSI resource, a CSI resource set, a CSI resource group, a CSI resource setting, and a CSI resource set group.

35. A communication apparatus comprising a processor configured to implement a method recited in any one or more of solutions 1 to 34.

36. A computer readable medium having code stored thereon, the code, when executed, causing a processor to implement a method recited in any one or more of solutions 1 to 34.

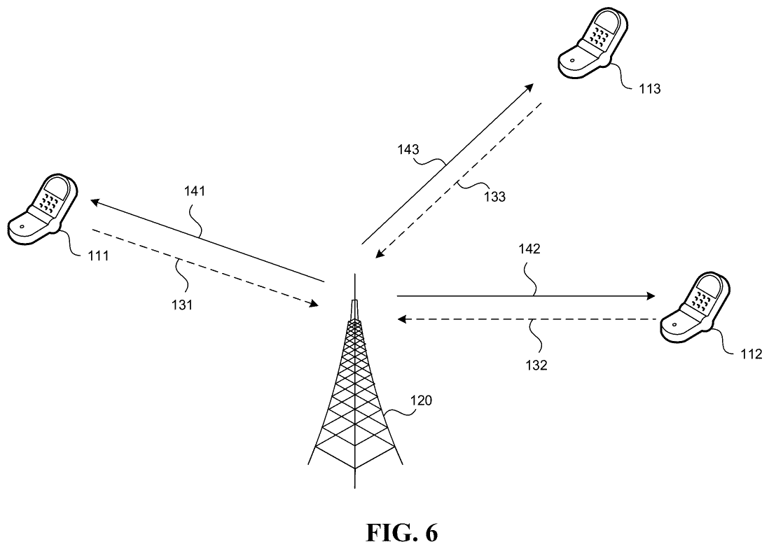

FIG. 6 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

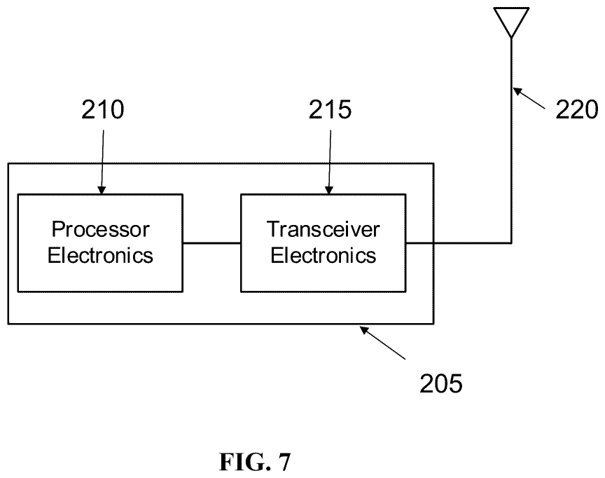

FIG. 7 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
receiving, by a wireless communication device, from a network device, a radio resource control (RRC) signaling,
wherein the RRC signaling includes at least a channel state information (CSI) report configuration and a CSI resource configuration; and
performing, by the wireless communication device, a CSI reporting according to the RRC signaling,
wherein the CSI reporting contains two or more CSI sub-reports, and
wherein each CSI sub-report of the two or more CSI sub-reports includes one or more CSI parameters.

2. The method of claim 1, wherein a first resource is associated with a first CSI sub-report of the two or more CSI sub-reports for the CSI reporting;
wherein a second resource is associated with a second CSI sub-report of the two or more CSI sub-reports for the CSI reporting;
wherein the first resource is different from the second resource; and
wherein the first resource is within a subset of the second resource.

3. The method of claim 1, wherein the two or more CSI sub-reports are jointly reported;
wherein each of the jointly reported CSI sub-reports contain at least one CSI parameter of a same type; and
wherein each of the at least one CSI parameter of the same type are jointly coded and reported instantly.

4. The method of claim 1, wherein the performing, by the wireless communication device, the CSI reporting according to the RRC signaling comprises:
reporting a first CSI parameter of a first CSI sub-report of the two or more CSI sub-reports; or
reporting an offset value of a first CSI parameter of a second CSI sub-report of the two or more CSI sub-reports,
wherein the offset value of the first CSI parameter of the second CSI sub-report is a difference between a first reference CSI parameter and the first CSI parameter of the second CSI sub-report.

5. The method of claim 4, wherein the first CSI parameter of the first CSI sub-report is a wideband channel quality indicator (CQI); and
wherein the first CSI parameter of the second CSI sub-report is a wideband CQI.

6. The method of claim 4, wherein the first reference CSI parameter of a first CSI parameter in a N^{th} CSI sub-report of the two or more CSI sub-reports is a first CSI parameter in a (N−1)^{th} CSI sub-report of the two or more CSI sub-reports; and
wherein N is an integer number between 2 and 9.

7. The method of claim 4, wherein the first reference CSI parameter is at least one of: a wideband CQI of a type of CSI sub-report, a wideband CQI of a CSI sub-report associated with a predefined resource, a wideband CQI of a CSI sub-report associated with a largest resource, or a wideband CQI of a prior CSI sub-report.

8. The method of claim 4, wherein the first reference CSI parameter is a maximum first CSI parameter of a CSI sub-report of the two or more CSI sub-reports in the CSI reporting; and
the method further comprising reporting a resource ID associated with the maximum first CSI parameter of the CSI sub-report.

9. The method of claim 4, wherein the performing, by the wireless communication device, the CSI reporting according to the RRC signaling further comprises:
reporting an offset value of a second CSI parameter of the first or the second CSI sub-report,
wherein the offset value of the second CSI parameter is a difference between a second reference CSI parameter and the second CSI parameter, and
wherein the second CSI parameter is a subband CQI index.

10. The method of claim 9, wherein the second reference CSI parameter is at least one of: a wideband CQI of a type of CSI sub-report, a wideband CQI of a CSI sub-report associated with a predefined resource, a wideband CQI of a CSI sub-report associated with a largest resource, a maximum wideband CQI of a type of CSI sub-report, a subband CQI of a type of CSI sub-report, a subband CQI of a CSI sub-report associated with a largest resource, a subband CQI of a CSI sub-report associated with a predefined resource, or a subband CQI of a prior sub-report.

11. The method of claim 9, wherein the first CSI parameter of the first CSI sub-report, the offset value of the first CSI parameter of the second CSI sub-report, or the offset value of the second CSI parameter in the CSI reporting are reported or encoded according to a predefined order; and
wherein the predefined order is based on at least one of the following: a resource identification (ID), a resource group ID associated with a CSI reporting, the number of ports, the transmission power offsets, an order configured by a high layer signaling, a preconfigured order, or the number of ports or the transmission power offsets indicated in the CSI report configuration.

12. A method of wireless communication, comprising:
transmitting, by a network device, to a wireless communication device, a radio resource control (RRC) signaling,
wherein the RRC signaling includes at least a channel state information (CSI) report configuration and a CSI resource configuration; and
receiving, by the network device, from the wireless communication device, a CSI reporting according to the RRC signaling,
wherein the CSI reporting contains two or more CSI sub-reports,
wherein each CSI sub-report of the two or more CSI sub-reports includes one or more CSI parameters,
wherein a first CSI sub-report of the two or more CSI sub-reports and the one or more CSI parameters included in the first CSI sub-report are associated with a resource, and
wherein the resource is at least one of: a CSI resource, a CSI resource set, a CSI resource group, a CSI resource setting, or a CSI resource set group.

13. The method of claim 12, wherein the CSI report configuration contains more than one subband size, CQI bits per subband (cqi-BitsPerSubband), or CSI-reportingBand configuration; and
wherein a different resource is associated with a different subband size, a different CQI bits per subband (cqi-BitsPerSubband), or a different CSI-reportingBand configuration.

14. The method of claim 12, wherein a CSI parameter of the one or more CSI parameters associated with a different resource is reported via a different granularity; and
wherein the different granularity is configured by the RRC signaling or is predefined.

15. A wireless communication apparatus, comprising at least one processor configured to:
receive, from a network device, a radio resource control (RRC) signaling,
wherein the RRC signaling includes at least a channel state information (CSI) report configuration and a CSI resource configuration; and
perform a CSI reporting according to the RRC signaling,
wherein the CSI reporting contains two or more CSI sub-reports, and wherein each CSI sub-report of the two or more CSI sub-reports includes one or more CSI parameters.

16. The apparatus of claim 15, wherein a first resource is associated with a first CSI sub-report of the two or more CSI sub-reports for the CSI reporting;
wherein a second resource is associated with a second CSI sub-report of the two or more CSI sub-reports for the CSI reporting;
wherein the first resource is different from the second resource; and
wherein the first resource is within a subset of the second resource.

17. The apparatus of claim 15, wherein the at least one processor is configured, as part of the performing the CSI reporting, to jointly report the two or more CSI sub-reports;
wherein each of the jointly reported CSI sub-reports contain at least one CSI parameter of a same type; and
wherein each of the at least one CSI parameter of the same type are jointly coded and reported instantly.

18. The apparatus of claim 15, wherein the at least one processor is configured, as part of the performing the CSI reporting according to the RRC signaling, to:
report a first CSI parameter of a first CSI sub-report of the two or more CSI sub-reports; or
report an offset value of a first CSI parameter of a second CSI sub-report of the two or more CSI sub-reports,
wherein the offset value of the first CSI parameter of the second CSI sub-report is a difference between a first reference CSI parameter and the first CSI parameter of the second CSI sub-report.

19. The apparatus of claim 18, wherein the first CSI parameter of the first CSI sub-report is a wideband channel quality indicator (CQI); and
wherein the first CSI parameter of the second CSI sub-report is a wideband CQI.

20. The apparatus of claim 18, wherein the first reference CSI parameter of a first CSI parameter in a N^{th} CSI sub-report of the two or more CSI sub-reports is a first CSI parameter in a (N−1)^{th} CSI sub-report of the two or more CSI sub-reports; and
wherein N is an integer number between 2 and 9.
